(19) United States
(12) Patent Application Publication
(10) Pub. No.: US 2024/0179592 A1
(43) Pub. Date: May 30, 2024

(54) METHOD AND DEVICE FOR TIMING CONTROL IN A NON-TERRESTRIAL NETWORK

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil Suh, Hwaseong-si (KR); Gene Back Hahn, Hwaseong-si (KR); Ui Hyun Hong, Hwaseong-si (KR); Duk Kyung Kim, Seoul (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 18/430,358

(22) Filed: Feb. 1, 2024

Related U.S. Application Data
(63) Continuation of application No. PCT/KR2022/011216, filed on Jul. 29, 2022.

(30) Foreign Application Priority Data
Aug. 3, 2021 (KR) 10-2021-0102122

(51) Int. Cl. H04W 36/08; H04W 36/00

(52) U.S. Cl. CPC H04W 36/083; H04W 36/0072

(57) ABSTRACT

A method and a device for timing control in a non-terrestrial network are provided. The method includes: transmitting, to a UE, first system information including a first scheduling offset; determining a first update period of the first scheduling offset; transmitting, to the UE, a first message including information about the first update period; and transmitting, to the UE, a second message including information about a scheduling offset updated according to the first update period.

### CROSS-REFERENCE TO RELATED APPLICATIONS

This application is a Continuation of International Application No. PCT/KR2022/011216, filed on Jul. 29, 2022, which claims priority to Korean Patent Application No. 10-2021-0102122, filed on Aug. 3, 2021 with the Korean Intellectual Property Office (KIPO), the entire contents of which are hereby incorporated by reference.

### TECHNICAL FIELD

The present disclosure relates to a timing control technique for a non-terrestrial network.

### BACKGROUND

In order to provide enhanced communication services, a communication system (e.g., 5G communication network, 6G communication network, etc.) using a higher frequency band (e.g., a frequency band of 6 GHz or above) than a frequency band (e.g., a frequency band of 6 GHz or below) of the long term evolution (LTE) communication system (or, LTE-A communication system) is being considered. The 5G communication network (e.g., new radio (NR) communication network) may support not only a frequency band of 6 GHz or below, but also a frequency band of 6 GHz or above. The 5G communication network (e.g., new radio (NR) communication network) may also support various communication services and scenarios not supported by the LTE communication network. For example, usage scenarios of the 5G communication network may include enhanced Mobile BroadBand (eMBB), Ultra Reliable Low Latency Communication (URLLC), Massive Machine Type Communication (mMTC), and/or the like. In addition, in order to provide enhanced communication services compared to the 5G communication network, the 6G communication network may support various and wide frequency bands and may be applied to various usage scenarios (e.g., terrestrial communication, non-terrestrial communication, sidelink communication, and/or the like).

The communication network (e.g., 5G communication network, 6G communication network, etc.) may provide communication services to terminals located on the ground. Recently, the demand for communication services for not only terrestrial but also non-terrestrial scenarios, such as airplanes, drones, satellites, and the like has been increasing. Accordingly, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g., airplane, drone, and the like) may be performed based on 5G communication technology, 6G communication technology, and/or the like. In the NTN, the satellite may perform functions of a base station in a communication network (e.g., 5G communication network, 6G communication network, and/or the like).

In a terrestrial network (TN), a handover procedure may be performed based on reference signal received power (RSRP). Although communication services are provided over a wide area due to the high altitudes of satellites in an NTN, the difference in RSRP in that area may be relatively small. Due to the random characteristics of a channel in the NTN, the RSRP-based handover procedure may not be as effective as the handover procedure in the TN. In addition, in the NTN, it may be difficult to precisely configure a cell coverage based on reception quality alone, such as RSRP and reference signal received quality (RSRQ).

### SUMMARY

Due to the prolonged delay in channels in the NTN, an increase in the utility of a conditional handover (CHO) procedure is anticipated. However, as the CHO procedure is performed based on RSRP, improvements to the CHO procedure are required.

Embodiments of the present disclosure provide a method and an apparatus for update and signaling of a scheduling offset in a non-terrestrial network.

According to an embodiment, a method is provided that may be performed by a satellite. The method includes transmitting first system information including a first scheduling offset to a user equipment (UE). The method also includes determining a first update periodicity of the first scheduling offset. The method additionally includes transmitting a first message including information on the first update periodicity to the UE. The method further includes transmitting a second message including information on a scheduling offset updated according to the first update periodicity to the UE. Each of the first scheduling offset and the updated scheduling offset is used to determine an uplink transmission timing at the UE.

The method may further include transmitting a third message including information on a second update periodicity of the first scheduling offset to the UE. The method may additionally include transmitting a fourth message including information on a scheduling offset updated according to the second update periodicity to the UE. The second update periodicity may be different from the first update periodicity.

The method may further include, when a preset condition is satisfied, changing an update periodicity of the first scheduling offset from the first update periodicity to the second update periodicity.

The preset condition may include at least one of a case when an elevation angle between the satellite and a cell formed by the satellite exceeds a first threshold, a case when the elevation angle is equal to or less than the first threshold, a case when a distance between the satellite and the cell exceeds a second threshold, and/or a case when the distance is equal to or less than the second threshold.

The method may further include transmitting second system information including a second scheduling offset to the UE. The method may also include determining a third update periodicity of the second scheduling offset; transmitting a fifth message including information on the third update periodicity to the UE. The method may further still include transmitting a sixth message including information on a scheduling offset updated according to the third update periodicity to the UE. The third update periodicity may be different from the first update periodicity.

The first scheduling offset may be at least one of a cell-specific K offset or a UE-specific K offset.

The first message may be a radio resource control (RRC) message. The second message may be a medium access control (MAC) control element (CE).

The information on the updated scheduling offset may indicate at least one of an increase amount or a decrease amount compared to the first scheduling offset or a previous scheduling offset.

According to another embodiment, a method is provided that may be performed by a user equipment (UE). The method includes receiving first system information including a first scheduling offset from a satellite. The method also includes receiving a first message including information on a first update periodicity of the first scheduling offset from the satellite. The method additionally includes receiving a second message including information on a scheduling offset updated according to the first update periodicity from the satellite. The method further includes determining an uplink transmission timing based on the updated scheduling offset. The method further still includes performing uplink transmission based on the uplink transmission timing.

The method may further include receiving a third message including information on a second update periodicity of the first scheduling offset from the satellite; and receiving a fourth message including information on a scheduling offset updated according to the second update periodicity from the satellite. The second update periodicity may be different from the first update periodicity.

An update periodicity of the first scheduling offset may be changed from the first update periodicity to the second update periodicity when a preset condition is satisfied in the satellite.

The method may further include receiving second system information including a second scheduling offset from the satellite. The method may additionally include receiving a fifth message including information on a third update periodicity of the second scheduling offset from the satellite. The method may further still include receiving a sixth message including information on a scheduling offset updated according to the third update periodicity from the satellite. The third update periodicity may be different from the first update periodicity.

The first scheduling offset may be at least one of a cell-specific K offset or a UE-specific K offset.

The first message may be a radio resource control (RRC) message. The second message may be a medium access control (MAC) control element (CE).

The information on the updated scheduling offset may indicate at least one of an increase amount or a decrease amount compared to the first scheduling offset or a previous scheduling offset.

According to yet another embodiment, a method is provided that may be performed in first cell. The method includes performing uplink communication with a user equipment (UE) according to an uplink transmission timing determined based on a first scheduling offset of the first cell. The method also includes determining a handover based on a measurement result received from the UE. The method additionally includes transmitting a handover (HO) request message to a second cell; receiving a HO request acknowledgement (ACK) message including a second scheduling offset of the second cell from the second cell. The method further includes transmitting a radio resource control (RRC) reconfiguration message including information on the second scheduling offset to the UE.

The HO request message may include an information element requesting transmission of the second scheduling offset.

The method may further include calculating a difference between the first scheduling offset and the second scheduling offset. The information on the second scheduling offset may include the difference.

The first cell and the second cell may be formed by one of a same satellite or different satellites.

Each of the first scheduling offset and the second scheduling offset may be at least one of a cell-specific K offset or a UE-specific K offset.

According to embodiments of the present disclosure, a satellite may periodically transmit a scheduling offset to UE. Additionally, the satellite can update the scheduling offset based on its mobility and transmit the updated scheduling offset to the UE. The transmission periodicity of the updated scheduling offset may be changed when a preset condition is satisfied. During a handover procedure, a source cell may transmit information on a scheduling offset of a target cell to the UE. The UE, based on the scheduling offset (e.g., updated scheduling offset) received from the satellite or a cell, can determine an uplink transmission timing and perform uplink transmission accordingly. Accordingly, the uplink transmission can be performed efficiently, leading to improvements of the performance of the communication system.

### BRIEF DESCRIPTION OF THE DRAWINGS

FIG. 1A is a conceptual diagram illustrating a first embodiment of a non-terrestrial network.

FIG. 1B is a conceptual diagram illustrating a second embodiment of a non-terrestrial network.

FIG. 2A is a conceptual diagram illustrating a third embodiment of a non-terrestrial network.

FIG. 2B is a conceptual diagram illustrating a fourth embodiment of a non-terrestrial network.

FIG. 2C is a conceptual diagram illustrating a fifth embodiment of a non-terrestrial network.

FIG. 3 is a block diagram illustrating an embodiment of an entity constituting a non-terrestrial network.

FIG. 4A is a conceptual diagram illustrating an embodiment of a protocol stack of a user plane in a transparent payload-based non-terrestrial network.

FIG. 4B is a conceptual diagram illustrating an embodiment of a protocol stack of a control plane in a transparent payload-based non-terrestrial network.

FIG. 5A is a conceptual diagram illustrating an embodiment of a protocol stack of a user plane in a regenerative payload-based non-terrestrial network.

FIG. 5B is a conceptual diagram illustrating an embodiment of a protocol stack of a control plane in a regenerative payload-based non-terrestrial network.

FIG. 6 is a conceptual diagram illustrating an embodiment of a cell formed by a satellite in EFB NTN.

FIG. 7A is a conceptual diagram illustrating states of satellites and UEs at a first time in EFB NTN, according to an embodiment.

FIG. 7B is a conceptual diagram illustrating states of satellites and UEs at a second time in EFB NTN, according to an embodiment.

FIG. 7C is a conceptual diagram illustrating states of satellites and UEs at a third time in EFB NTN, according to an embodiment.

FIG. 8 is a sequence chart illustrating a first embodiment of a method for updating and signaling a scheduling offset.

FIG. 9 is a sequence chart illustrating a second embodiment of a method for updating and signaling a scheduling offset.

FIG. 10 is a sequence chart illustrating a third embodiment of a method for updating and signaling a scheduling offset.

FIG. 11 is a conceptual diagram illustrating an embodiment of a timing relationship between a source cell and a target cell.

FIG. 12 is a sequence chart illustrating an embodiment of a handover procedure in NTN.

### DETAILED DESCRIPTION

While the present disclosure is capable of various modifications and alternative forms, specific embodiments thereof are shown by way of example in the drawings and are described in detail below. It should be understood, however, that there is no intent to limit the present disclosure to the particular forms disclosed. On the contrary, the present disclosure is intended to cover all modifications, equivalents, and alternatives falling within the spirit and scope of the present disclosure. Like numbers refer to like elements throughout the description of the figures.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in the present disclosure, “one or more of A and B” may mean “one or more of A or B” or “one or more of combinations of one or more of A and B”.

In the present disclosure, “(re)transmission” may refer to “transmission”, “retransmission”, or “transmission and retransmission”. Further, “(re)configuration” may refer to “configuration”, “reconfiguration”, or “configuration and reconfiguration”. Additionally, “(re)connection” may refer to “connection”, “reconnection”, or “connection and reconnection”. Further, “(re)access” may mean “access”, “re-access”, or “access and re-access”. Also, “(re)selection” may mean “selection”, “reselection”, or “selection and reselection”.

It should be understood that when an element is referred to as being “connected” or “coupled” to another element, the element can be directly connected or coupled to the other element or one or more intervening elements may be present between the element and the other element. In contrast, when an element is referred to as being “directly connected” or “directly coupled” to another element, there are no intervening elements present between the element and the other element.

The terminology used herein is for the purpose of describing particular embodiments only and is not intended to be limiting of the present disclosure. As used herein, the singular forms are intended to include the plural forms as well, unless the context clearly indicates otherwise. It should be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure pertains. It should be further understood that terms, such as those defined in commonly used dictionaries, should be interpreted as having a meaning that is consistent with their meaning in the context of the relevant art and should not be interpreted in an idealized or overly formal sense unless expressly so defined herein. When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings. In order to facilitate general understanding in describing the present disclosure, the same components in the drawings are denoted with the same reference signs and repeated description thereof has been omitted. In addition to the embodiments explicitly described in the present disclosure, operations may be performed according to a combination of the embodiments, extensions of the embodiments, and/or modifications of the embodiments. Performance of some operations may be omitted and/or the order of performance of operations may be changed.

When a method (e.g., transmission or reception of a signal) performed at a first communication node among communication nodes is described, a corresponding second communication node may perform a method (e.g., reception or transmission of the signal) corresponding to the method performed at the first communication node. For example, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g., payload-based NTN), operations of a base station may refer to operations of a satellite and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), roadside unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In embodiments, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g., master information block (MIB), system information block (SIB)) and/or RRC messages. The MAC signaling may refer to a transmission and reception operation of a MAC control element (CE). The PHY signaling may refer to a transmission and reception operation of control information (e.g., downlink control information (DCI), uplink control information (UCI), and/or sidelink control information (SCI)).

In embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”.

A communication system may include at least one of a terrestrial network, non-terrestrial network, 4G communication network (e.g., long-term evolution (LTE) communication network), 5G communication network (e.g., new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which embodiments may be applied is not limited to the content described below. The embodiments may be applied to various communication networks (e.g., 4G communication network, 5G communication network, and/or 6G communication network). Aa communication network may be used in the same sense as a communication system.

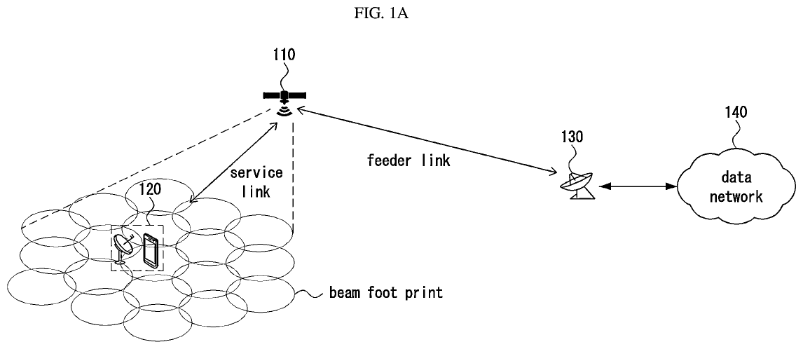

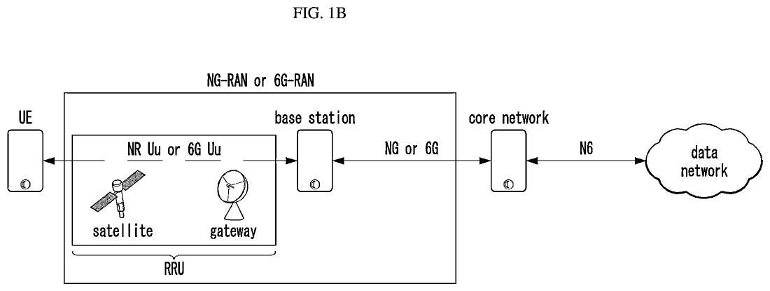

FIG. 1A is a conceptual diagram illustrating a first embodiment of a non-terrestrial network.

As shown in FIG. 1A, a non-terrestrial network (NTN) may include a satellite 110, a communication node 120, a gateway 130, and a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, and/or an unmanned aircraft system (UAS) platform. The UAS platform may include a high altitude platform station (HAPS). A non-GEO satellite may be an LEO satellite and/or MEO satellite.

The communication node 120 may include a communication node (e.g., a user equipment (UE) or a terminal) located on a terrestrial site and/or a communication node (e.g., an airplane, a drone) located on a non-terrestrial space. A service link may be established between the satellite 110 and the communication node 120. The service link may be a radio link, for example. The satellite 110 may provide communication services to the communication node 120 using one or more beams. The shape of a footprint of the beam of the satellite 110 may be elliptical or circular.

The communication node 120 may perform communications (e.g., downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g., base stations supporting 4G, 5G, and/or 6G functionality) as well as the satellite 110 and may perform DC operations based on the techniques defined in 4G, 5G, and/or 6G technical specifications.

The gateway 130 may be located on a terrestrial site. A feeder link may be established between the satellite 110 and the gateway 130. The feeder link may be a radio link, for example. The gateway 130 may be referred to as a ‘non-terrestrial network (NTN) gateway’. The communications between the satellite 110 and the gateway 130 may be performed based on an NR-Uu interface, a 6G-Uu interface, and/or a satellite radio interface (SRI). The gateway 130 may be connected to the data network 140. There may be a ‘core network’ between the gateway 130 and the data network 140. For example, the gateway 130 may be connected to the core network and the core network may be connected to the data network 140. The core network may support the 4G communication technology, 5G communication technology, and/or 6G communication technology. For example, the core network may include an access and mobility management function (AMF), a user plane function (UPF), a session management function (SMF), and/or the like. The communications between the gateway 130 and the core network may be performed based on an NG-C/U interface or 6G-C/U interface.

FIG. 1B is a conceptual diagram illustrating a second embodiment of a non-terrestrial network. According to the second embodiment of FIG. 1B, there may be a ‘core network’ between the gateway 130 and the data network 140 in a transparent payload-based NTN.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface. The communications between the base station and the core network (e.g., AMF, UPF, SMF, and/or the like) may be performed based on an NG-C/U interface or 6G-C/U interface.

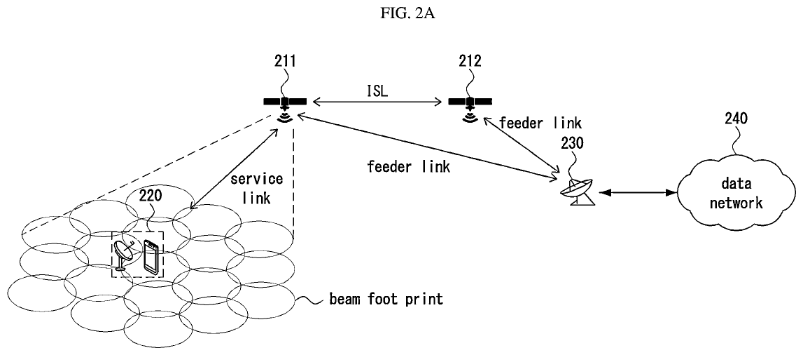

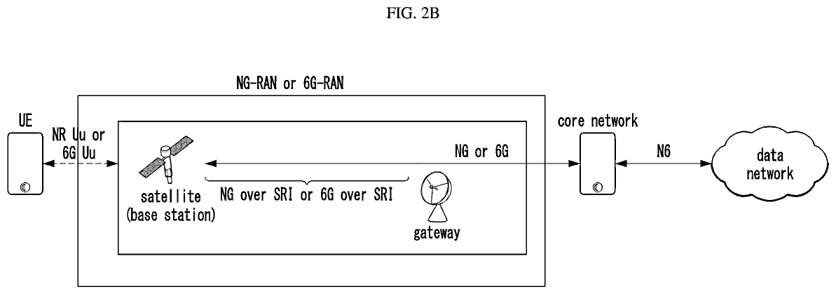

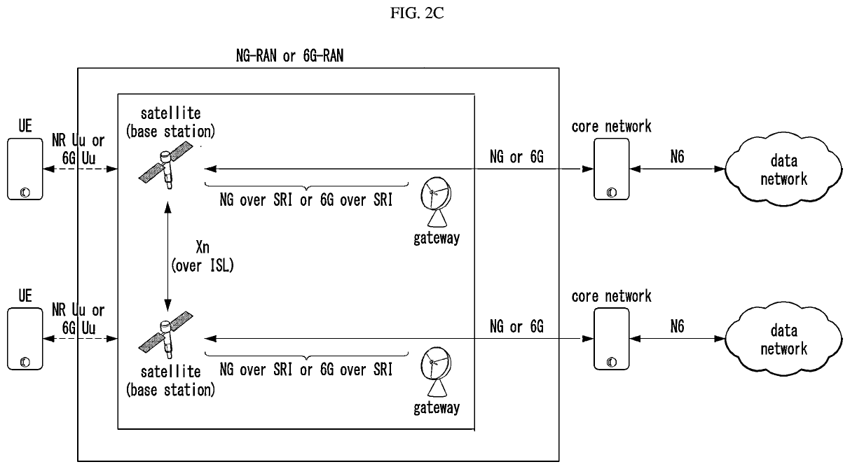

FIG. 2A is a conceptual diagram illustrating a third embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230) and may transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212.An inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and/or a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g., base stations supporting 4G, 5G, and/or 6G functionality) as well as the satellite 211. The communication node 220 may perform DC operations based on the techniques defined in 4G, 5G, and/or 6G technical specifications.

The gateway 230 may be located on a terrestrial site. A feeder link may be established between the satellite 211 and the gateway 230. Also, a feeder link may be established between the satellite 212 and the gateway 230. The feeder link may be a radio link, for example. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

FIG. 2B is a conceptual diagram illustrating a fourth embodiment of a non-terrestrial network. FIG. 2C is a conceptual diagram illustrating a fifth embodiment of a non-terrestrial network. As shown in FIG. 2B and FIG. 2C, there may be a ‘core network’ between the gateway 230 and the data network 240.

As shown in FIG. 2B and FIG. 2C, the gateway may be connected with the core network and the core network may be connected with the data network. The core network may support the 4G communication technology, 5G communication technology, and/or 6G communication technology. The core network may include AMF, UPF, SMF, and/or the like. Communication between the gateway and the core network may be performed based on an NG-C/U interface or 6G-C/U interface. Functions of a base station may be performed by the satellite. In other words, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established. In the non-terrestrial network of FIG. 2C, an ISL between satellites may be established.

The entities (e.g., satellite, base station, UE, communication node, gateway, and the like) constituting the non-terrestrial network shown in FIGS. 1A, 1B, 2A, 2B, and/or 2C may be configured as follows.

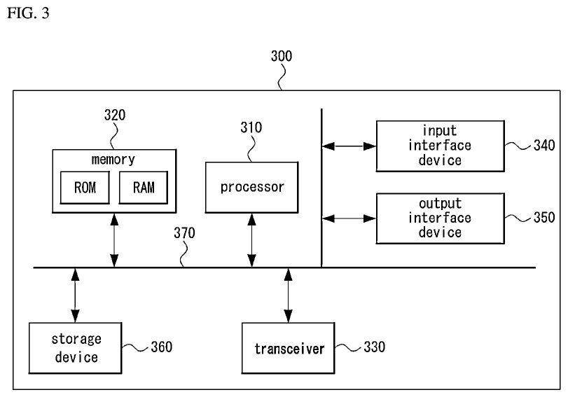

FIG. 3 is a block diagram illustrating an embodiment of an entity constituting a non-terrestrial network.

As shown in FIG. 3, an entity 300 may include at least one processor 310, a memory 320, and a transceiver 330 connected to a network to perform communication. In addition, the entity 300 may further include an input interface device 340, an output interface device 350, a storage device 360, and/or the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to embodiments of the present disclosure may be performed. Each of the memory 320 and the storage device 360 may be configured as at least one of a volatile storage medium and/or a nonvolatile storage medium. For example, the memory 320 may be configured with at least one of a read only memory (ROM) and/or a random access memory (RAM).

In embodiments, NTN reference scenarios may be defined as shown in Table 1 below.

TABLE 1
When the satellite 110 in the NTN shown in FIG. 1A and/or FIG.
1B is a GEO satellite (e.g., a GEO satellite that supports a transparent
function), this may be referred to as ‘scenario A’. When the
satellites 211 and 212 in the NTN shown in FIG. 2A, FIG. 2B, and/or
FIG. 2C are GEO satellites (e.g., GEOs that support a regenerative
function), this may be referred to as ‘scenario B’.

| | NTN shown in FIG. 1 | NTN shown in FIG. 2 |
|---|---|---|
| GEO | Scenario A | Scenario B |
| LEO (steerable beams) | Scenario C1 | Scenario D1 |
| LEO (beams moving | Scenario C2 | Scenario D2 |
| with satellite) | | |

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’. Parameters for the scenarios defined in Table 1, according to embodiments, may be defined as shown in Table 2 below.

Parameters for the NTN reference scenarios defined in Table 1, according to embodiments, may be defined as shown in Table 2 below.

TABLE 2

| | Scenarios A and B | Scenarios C and D |
|---|---|---|
| Altitude | 35,786 kilometers (km) | 600 km |
| | | 1,200 km |
| Spectrum (service link) | <6 GHz (e.g., 2 GHz) | |
| | >6 GHz (e.g., DL 20 GHz, UL 30 GHz) | |
| Maximum channel | 30 MHz for band <6 GHz | |
| bandwidth capability | 1 GHz for band >6 GHz | |
| (service link) | | |
| Maximum distance | 40,581 km | 1,932 km (altitude of 600 km) |
| between satellite and | | 3,131 km (altitude of 1,200 km) |
| communication node (e.g., | | |
| UE) at the minimum | | |
| elevation angle | | |
| Maximum round trip | Scenario A: 541.46 | Scenario C: (transparent |
| delay (RTD) | milliseconds (ms) | payload: service and feeder links) |
| (only propagation delay) | (service and feeder links) | −5.77 ms (altitude of 600 km) |
| | Scenario B: 270.73 ms | −41.77 ms (altitude of 1,200 km) |
| | (only service link) | Scenario D: (regenerative |
| | | payload: only service link) |
| | | −12.89 ms (altitude of 600 km) |
| | | −20.89 ms (altitude of 1,200 km) |
| Maximum differential | 10.3 ms | 3.12 ms (altitude of 600 km) |
| delay within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1. delay constraints may be defined as shown in Table 3 below.

TABLE 3

| | | | Scenario | | Scenario | |
|---|---|---|---|---|---|---|
| | Scenario A | Scenario B | C1-2 | | D1-2 | |
| Satellite altitude | 35,786 km | | 600 km | | | |
| Maximum RTD | 541.75 ms | 270.57 ms | 28.41 | ms | 12.88 | ms |
| in a radio | (worst case) | | | | | |
| interface | | | | | | |
| between base | | | | | | |
| station and UE | | | | | | |
| Minimum RTD | 477.14 ms | 238.57 ms | 8 | ms | 4 | ms |
| in a radio | | | | | | |
| interface | | | | | | |
| between base | | | | | | |
| station and UE | | | | | | |

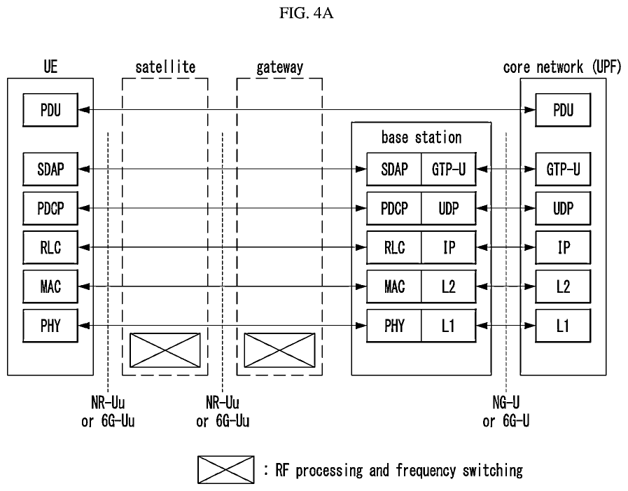

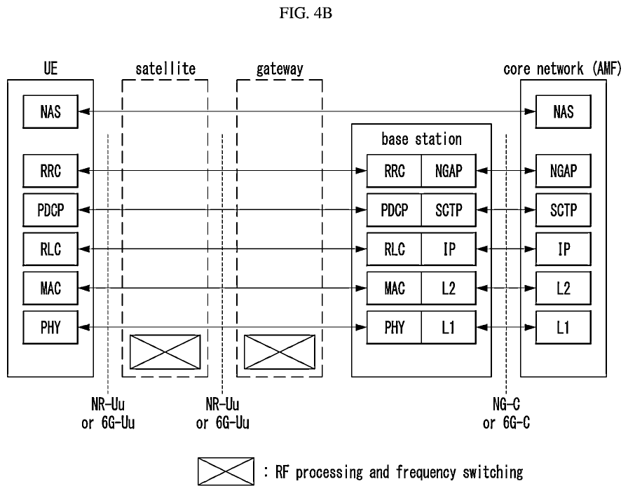

FIG. 4A is a conceptual diagram illustrating an embodiment of a protocol stack of a user plane in a transparent payload-based non-terrestrial network. FIG. 4B is a conceptual diagram illustrating an embodiment of a protocol stack of a control plane in a transparent payload-based non-terrestrial network.

As shown in FIGS. 4A and 4B, user data may be transmitted and received between a UE and a core network (e.g., UPF) and control data (e.g., control information) may be transmitted and received between the UE and the core network (e.g., AMF). Each of the user data the and control data may be transmitted and received through a satellite and/or gateway. The protocol stack of the user plane shown in FIG. 4A may be applied identically or similarly to a 6G communication network. The protocol stack of the control plane shown in FIG. 4B may be applied identically or similarly to a 6G communication network.

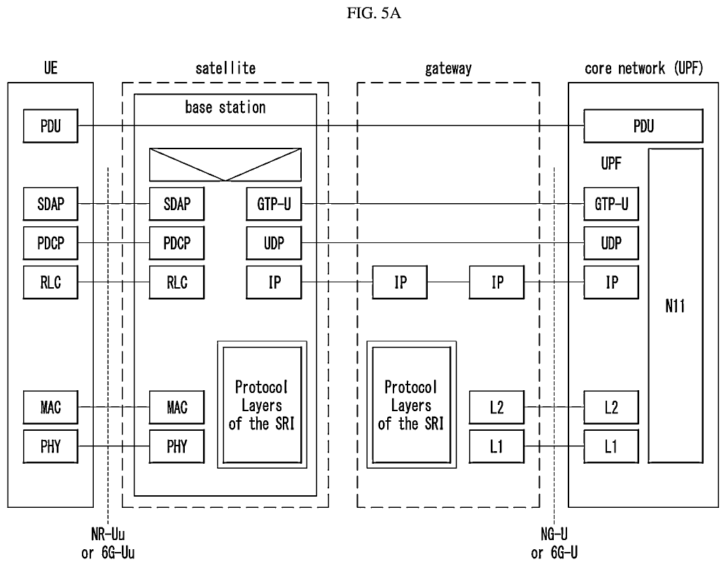

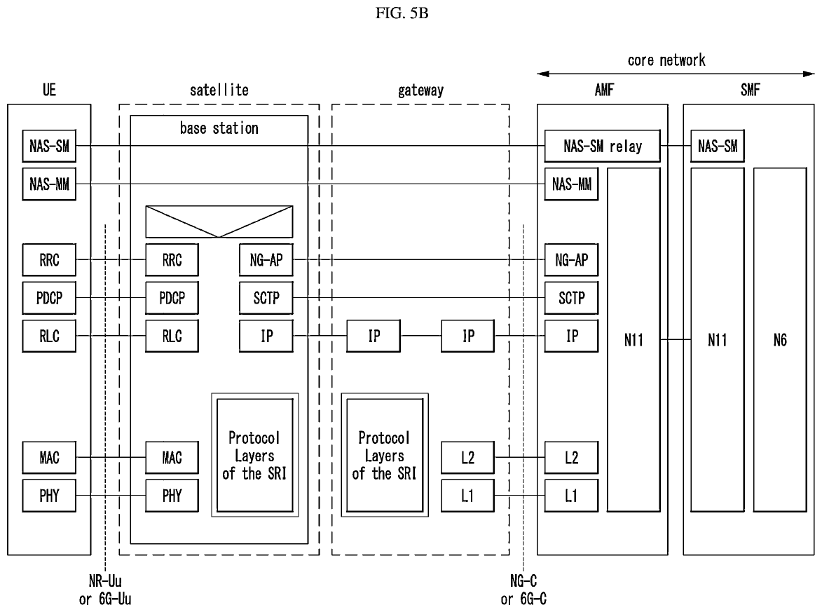

FIG. 5A is a conceptual diagram illustrating an embodiment of a protocol stack of a user plane in a regenerative payload-based non-terrestrial network. FIG. 5B is a conceptual diagram illustrating an embodiment of a protocol stack of a control plane in a regenerative payload-based non-terrestrial network.

As shown in FIGS. 5A and 5B, each of user data and control data (e.g., control information) may be transmitted and received through an interface between a UE and a satellite (e.g., base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

In embodiments, scheduling offsets used for timing relationships in the NTN may be introduced. The scheduling offset may be a K offset (i.e., K_{offset}). The K offset may be used to determine a timing of uplink transmission based on downlink transmission. The K offset may be classified into a cell-specific K offset and a UE-specific K offset. The cell-specific K offset may be referred to as cellSpecificKoffset. The UE-specific K offset may be referred to as UESpecificKoffset.

In the NTN, a beam of a satellite may have earth moving beam (EMB) characteristics or earth fixed beam (EFB) characteristics. An NTN including a satellite with EMB characteristics may be referred to as ‘EMB NTN’. An NTN including a satellite with EFB characteristics may be referred to as ‘EFB NTN’. In the EMB NTN, distances and elevation angles between UE(s) within a cell formed by a satellite and the satellite may be similar. Therefore, in the EMB NTN, the cell-specific K offset may be set to a fixed value for each cell. In the EFB NTN, distances between UE(s), within a cell formed by a satellite, and the satellite, a distance between the satellite and the cell, and/or delay times may change depending on a mobility of the satellite. Accordingly, updating the cell-specific K offset in the EFB NTN may be necessary. In the NTN, the UE-specific K offset may be used together with the cell-specific K offset. In this case, updating the UE-specific K offset may be necessary. Methods of updating the scheduling offset (e.g., cell-specific K offset and/or UE-specific K offset) and/or methods of signaling the updated scheduling offset, according to embodiments, are described below.

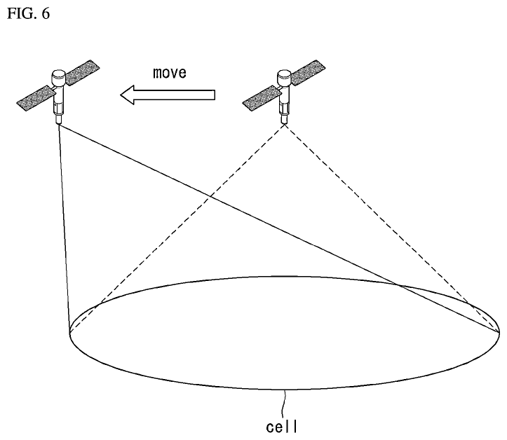

FIG. 6 is a conceptual diagram illustrating an embodiment of a cell formed by a satellite in EFB NTN.

As shown in FIG. 6, even when a satellite moves in an EFB NTN, a cell (e.g., cell coverage, beam coverage) may be maintained on the ground. The satellite may provide a fixed cell coverage by performing a beam steering operation and/or beam switching operation. At a time when a new satellite starts to provide communication services to a UE, an elevation angle may be the smallest. As the satellite moves, the elevation angle may increase. As the satellite moves, the elevation angle may decrease until a time at which the satellite's communication services are no longer provided. A distance between the satellite and the cell may also increase until that time.

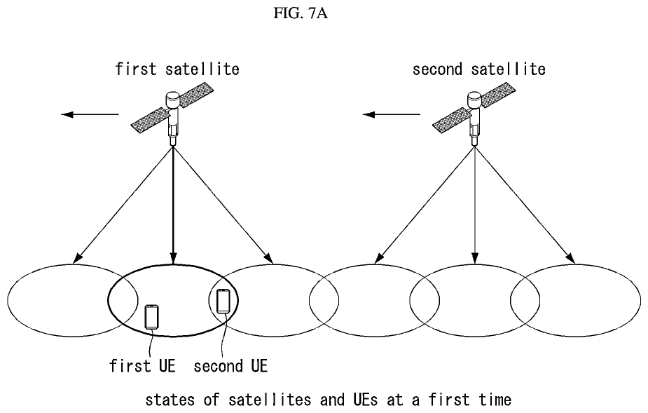

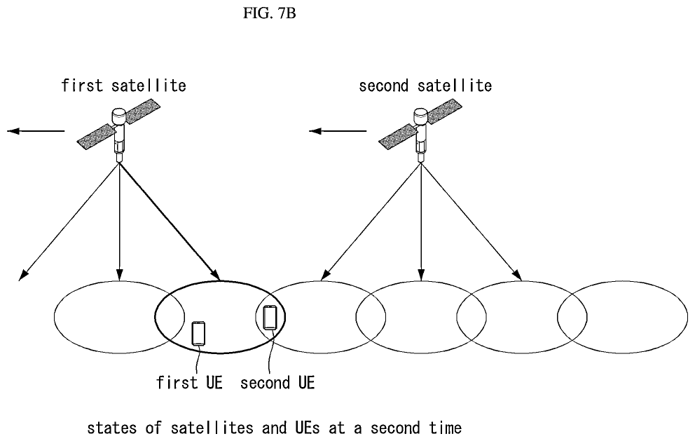

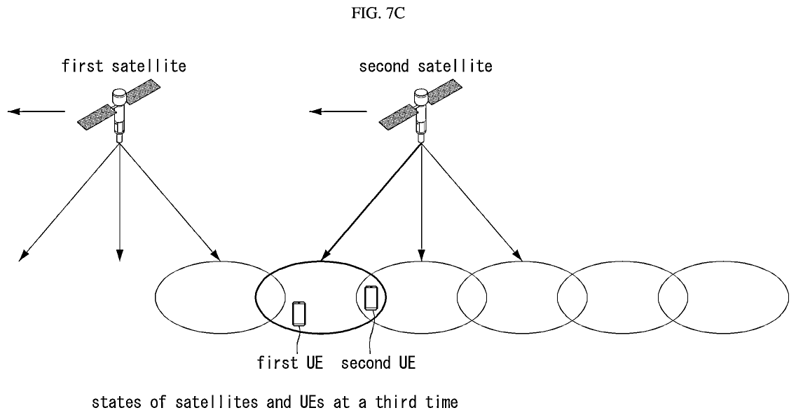

FIG. 7A is a conceptual diagram illustrating states of satellites and UEs at a first time in EFB NTN, according to an embodiment. FIG. 7B is a conceptual diagram illustrating states of satellites and UEs at a second time in EFB NTN, according to an embodiment. FIG. 7C is a conceptual diagram illustrating states of satellites and UEs at a third time in EFB NTN, according to an embodiment.

As shown in FIGS. 7A-7C, in the EFB NTN, a distance between a satellite and a cell may change according to movement of the satellite. As the distance between the satellite and the cell changes, a delay between the satellite and a UE belonging to the cell may change. The same satellite may support an earth fixed cell (EFC) by performing beam switching operations. Due to mobility of satellites, if a first satellite cannot provide communication services for a cell, a new second satellite may provide communication services for the cell. In an inter-satellite (SAT) handover procedure, all UEs in the cell may be handed over to a new satellite almost simultaneously. A probability that the UE(s) are to be handed over to the new satellite (e.g., second satellite) at a second time may be higher than a probability that the UE(s) are to be handed over to the new satellite (e.g., second satellite) at a first time. A probability that the UE(s) are to be handed over to a new satellite (e.g., third satellite) may be the lowest.

### Method for Setting and Updating a Scheduling Offset in EFB NTN

In the EFB NTN, a terrestrial cell (e.g., cell coverage) may be maintained regardless of mobility of a satellite. As the satellite moves, a distance between the satellite and the cell may change. Accordingly, a delay time between the satellite and UE(s) belonging to the cell may change. In this case, updating the cell-specific K offset may be necessary. The cell-specific K offset may increase as the distance between the satellite and the cell increases. For example, the cell-specific K offset may increase as an elevation angle between the satellite and the cell decreases. The cell-specific K offset may decrease as the distance between the satellite and the cell decreases. For example, the cell-specific K offset may decrease as the elevation angle between the satellite and the cell increases.

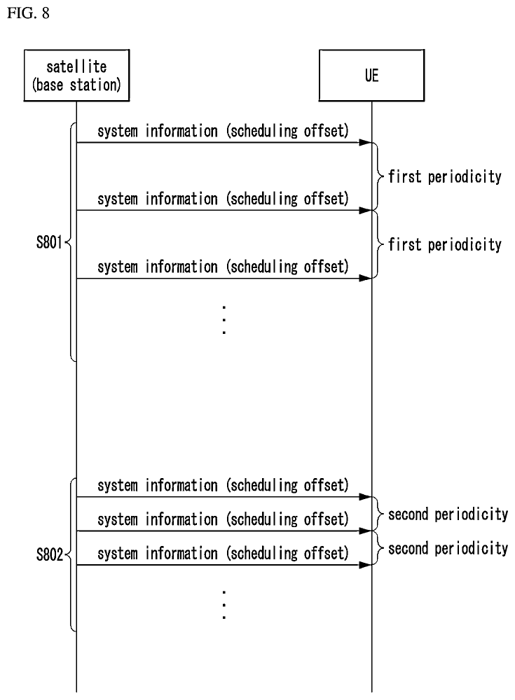

FIG. 8 is a sequence chart illustrating a first embodiment of a method for updating and signaling a scheduling offset.

As shown in FIG. 8, a satellite (e.g., base station) may set a scheduling offset and generate system information including the scheduling offset. The scheduling offset may include a cell-specific K offset and/or a UE-specific K offset. The system information including the scheduling offset may be a system information block 19 (SIB19). The SIB19 may include NTN configuration information (i.e., ntn-Config), and the NTN configuration information may include information on the scheduling

The satellite may transmit the system information including the scheduling offset according to a first periodicity in a step or operation S801. The same scheduling offset may be transmitted in the step or operation S801. The UE may receive the system information from the satellite and identify the scheduling offset included in the system information. The UE may consider the scheduling offset set by the satellite to determine a timing of UL transmission based on DL transmission. The UE may perform UL transmission at the determined timing.

When a preset condition is satisfied, the satellite may change the transmission periodicity of the system information from the first periodicity to a second periodicity. The second periodicity may be shorter than the first periodicity. Alternatively, the second periodicity may be longer than the first periodicity. The condition for changing the transmission periodicity of the system information including the scheduling offset may be condition(s) defined in Table 4 below. A combination of the conditions defined in Table 4 below may be used.

TABLE 4

| | Description |
|---|---|
| Condition 1 | Elevation angle between satellite and cell > threshold |
| Condition 2 | Elevation angle between satellite and cell ≤ threshold |
| Condition 3 | Distance between satellite and cell > threshold |
| Condition 4 | Distance between satellite and cell ≤ threshold |

Ephemeris information as well as the condition(s) defined in Table 4 may be considered to change the transmission periodicity of system information. Considering signaling overhead, it may be beneficial for the system information including the scheduling offset to have a long transmission periodicity. For quick acquisition of the scheduling offset in the UE, it may be beneficial for the system information including the scheduling offset to have a short transmission periodicity. When a time at which the satellite cannot provide communication services to the cell is imminent, a probability of cell reselection is relatively high, so it may be beneficial for the system information including the scheduling offset to have a short transmission periodicity.

The threshold (e.g., threshold defined in Table 4) that is a criterion for changing the transmission periodicity of system information, first periodicity, and/or second periodicity may be included in the system information that may be signaled from the satellite to the UE. The system information including the threshold, first periodicity, and/or second periodicity may be the system information (e.g., SIB19) transmitted in the step or operation S801 and/or a step or operation S802. Alternatively, the system information including the threshold, first periodicity, and/or second periodicity may be included in other system information (e.g., MIB, SIB1, etc.).

The satellite may transmit the system information including the scheduling offset according to the second periodicity in the step or operation S802. The same scheduling offset may be transmitted in the step or operation S802. The UE may receive the system information from the satellite and identify the scheduling offset included in the system information. The UE may consider the scheduling offset set by the satellite to determine a timing of UL transmission based on DL transmission. The UE may perform UL transmission at the determined timing.

The value of the scheduling offset transmitted in the step or operation S801 may be different from the value of the scheduling offset transmitted in the step S802. For example, the value of the scheduling offset transmitted in the step or operation S801 may be greater than or equal to the value of the scheduling offset transmitted in the step or operation S802. Alternatively, the value of the scheduling offset transmitted in the step or operation S801 may be smaller than the value of the scheduling offset transmitted in the step or operation S802. The scheduling offset transmitted in the step or operation S802 may be a scheduling offset obtained by updating the scheduling offset transmitted in the step or operation S801.

Alternatively, the same scheduling offset may be transmitted in the steps or operation S801 and S802.

In the above-described embodiment, the first periodicity may have a long duration and the second periodicity may have a short duration. The long duration may be set as a default value and the short duration may be selected according to specific condition(s). The short duration may be selected within {A ms, B ms, C ms, . . . } according to specific condition(s). A, B, and C may each be a natural number. A may be smaller than B. B may be smaller than C. As the specific condition(s), the condition(s) defined in Table 4 or a combination of the conditions defined in Table 4 may be considered. In Table 4, the thresholds may be subdivided into a first threshold, second threshold, and the like. The first threshold may be greater than the second threshold. For example, when the elevation angle between satellite and cell is greater than the first threshold, the short duration may be set to A ms. When the first threshold is equal to or greater than the elevation angle between satellite and cell, and the elevation angle between satellite and cell is greater than the second threshold, the short duration may be set to B ms.

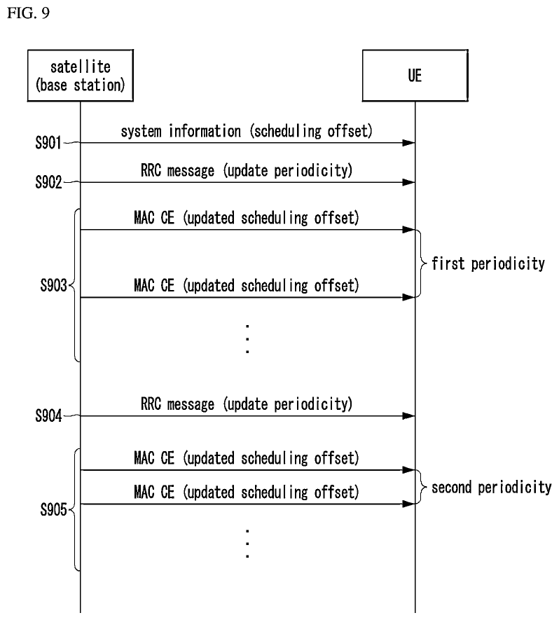

FIG. 9 is a sequence chart illustrating a second embodiment of a method for updating and signaling a scheduling offset.

As shown in FIG. 9, a satellite (e.g., base station) may set a scheduling offset and generate system information including the scheduling offset. The scheduling offset may include a cell-specific K offset and/or a UE-specific K offset. The system information including the scheduling offset may be an SIB19. The SIB19 may include NTN configuration information (e.g., ntn-Config), and the NTN configuration information may include the scheduling offset.

The satellite may transmit the system information including the scheduling offset according to a first periodicity in a step or operation S901. A UE may receive the system information from the satellite and identify the scheduling offset included in the system information. The UE may consider the scheduling offset set by the satellite to determine a timing of UL transmission based on DL transmission. The satellite may determine an update periodicity of the scheduling offset (e.g., cell-specific K offset and/or UE-specific K offset) and may transmit a message (e.g., RRC message) including information on the update periodicity in a step or operation S902. The information on the update periodicity transmitted in the step or operation S902 may indicate the first periodicity. The update periodicity may be the same as a transmission periodicity of updated scheduling offset. The information on the update periodicity may be transmitted through system information or a MAC message instead of the RRC message. The UE may receive the RRC message from the satellite and identify the update periodicity of the scheduling offset based on an information element included in the RRC message.

The satellite may update the scheduling offset based on the update periodicity and generate a MAC CE (e.g., MAC message) including information on the updated scheduling offset. The information on the updated scheduling offset may indicate an increase or decrease amount compared to a reference scheduling offset or default scheduling offset. The reference scheduling offset or default scheduling offset may be the scheduling offset set in the step or operation S901. Alternatively, the reference scheduling offset may mean the scheduling offset before being updated (e.g., previous scheduling offset). The satellite may transmit a message (e.g., MAC CE) including information on the scheduling offset updated according to the update periodicity in a step or operation S903. The UE may receive the MAC CE from the satellite and identify the current scheduling offset (e.g., updated scheduling offset) based on an information element (e.g., information on the updated scheduling offset) included in the MAC CE. The UE may consider the updated scheduling offset to determine a timing of UL transmission based on DL transmission. The UE may perform UL transmission based on the determined timing.

When preset condition(s) are satisfied, the satellite may change the update periodicity of the scheduling offset from the first periodicity to a second periodicity. The second periodicity may be shorter than the first periodicity. Alternatively, the second periodicity may be longer than the first periodicity. The condition(s) for changing the update periodicity may be the condition(s) defined in Table 4 above or a combination of the conditions defined in Table 4 above. The satellite may transmit a message (e.g., RRC message) including information on the changed update periodicity of the scheduling offset (e.g., cell-specific K offset and/or UE-specific K offset) in a step or operation S904. The information on the update periodicity transmitted in the step or operation S904 may indicate the second periodicity. The information on the update periodicity may be the same as a transmission periodicity of updated scheduling offset. The information on the update periodicity may be transmitted through system information or a MAC messages instead of the RRC message. The UE may receive the RRC message from the satellite and identify the update periodicity of the scheduling offset based on an information element included in the RRC message.

The satellite may update the scheduling offset based on the update periodicity and generate a message (e.g., MAC CE, MAC message, etc.) including information on the updated scheduling offset. The information on the updated scheduling offset may indicate an increase or decrease amount compared to a reference scheduling offset or default scheduling offset. The reference scheduling offset or default scheduling offset may be the scheduling offset set in the step S901. Alternatively, the reference scheduling offset may mean the scheduling offset before being updated (e.g., the scheduling offset last updated in the step or operation S903). The satellite may transmit a message (e.g., MAC CE) including information on the scheduling offset updated according to the update periodicity in a step or operation S905.

The UE may receive the MAC CE from the satellite and identify the current scheduling offset (e.g., updated scheduling offset) based on the information element (e.g., information of the updated scheduling offset) included in the MAC CE. The UE may consider the updated scheduling offset to determine a timing of UL transmission based on DL transmission. The UE may perform UL transmission based on the determined timing.

In the above-described embodiment, the satellite may use system information to set or indicate a cell-specific K offset to the UE and may use a MAC CE to set or indicate a UE-specific K offset (e.g., updated UE-specific K offset) to the UE. Alternatively, the satellite may set or indicate a cell-specific K offset to the UE by using system information and may set or indicate an updated cell-specific K offset to the UE by using a MAC CE. In an example, a reference value or default value of each of the cell-specific K offset and the UE-specific K-offset may be set by system information, and the MAC CE may be used to update the cell-specific K offset and/or the UE-specific K-offset.

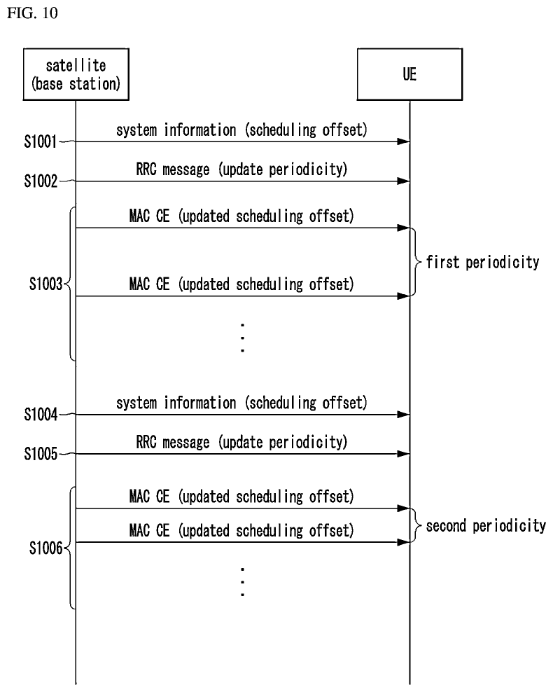

FIG. 10 is a sequence chart illustrating a third embodiment of a method for updating and signaling a scheduling offset.

The third embodiment shown in FIG. 10 may be a combination of the first embodiment shown in FIG. 8 and the second embodiment shown in FIG. 9. A satellite may set or indicate a scheduling offset (e.g., cell-specific K offset and/or UE-specific K offset) to a UE using system information in steps or operations S1001, S1004. The satellite may set or indicate an update periodicity of the scheduling offset to the UE by using a message (e.g., RRC message) in steps or operations S1002, S1005. The update periodicity of the scheduling offset(s) may be the same as a transmission periodicity of updated scheduling offset. The satellite may update the scheduling offset based on the update periodicity, and use a message (e.g., MAC CE) to set or indicate information on the updated scheduling offset (e.g., increase or decrease amount compared to a reference scheduling offset or default scheduling offset) to the UE in steps or operations S1003, S1006.

The UE may identify the scheduling offset based on the system information received from the satellite. The UE may identify the update periodicity of the scheduling offset based on the RRC message received from the satellite. The UE may receive information on the updated scheduling offset from the satellite by performing a monitoring operation according to the update periodicity. The UE may consider the updated scheduling offset to determine a timing of UL transmission based on DL transmission. The UE may perform UL transmission based on the determined timing.

In the above-described embodiment, system information may be used to set or indicate a cell-specific K offset and a MAC CE may be used to set or indicate a UE-specific K offset (e.g., updated UE-specific K offset). Alternatively, a MAC CE may be used to set or indicate an updated cell-specific K offset. In an example, a reference value or default value of each of the cell-specific K offset and the UE-specific K-offset may be set by system information, and a MAC CE may be used to update the cell-specific K offset and/or the UE-specific K-offset.

In the above-described embodiment, the update periodicity of the scheduling offset may be set within a range of a minimum periodicity and a maximum periodicity. The minimum periodicity may be Pₘᵢₙ milliseconds (ms), and the maximum periodicity may be Pₘₐₓ ms. Alternatively, each of the minimum periodicity and maximum periodicity may be set in units of slots.

### Method of Setting and Updating a Scheduling Offset in a Handover Procedure of EFB NTN

When the method for setting and signaling the scheduling offset described above is applied, the UE may need to obtain a scheduling offset (e.g., cell-specific K offset) of a new cell in a handover procedure. Since a scheduling offset of a source cell (e.g., serving cell) and a scheduling offset of a target cell may be different, an operation of signaling information on the scheduling offset of the target cell may be required. According to the above-described operation, a timing of a DL/UL transmission operation in the target cell may be adjusted (e.g., aligned).

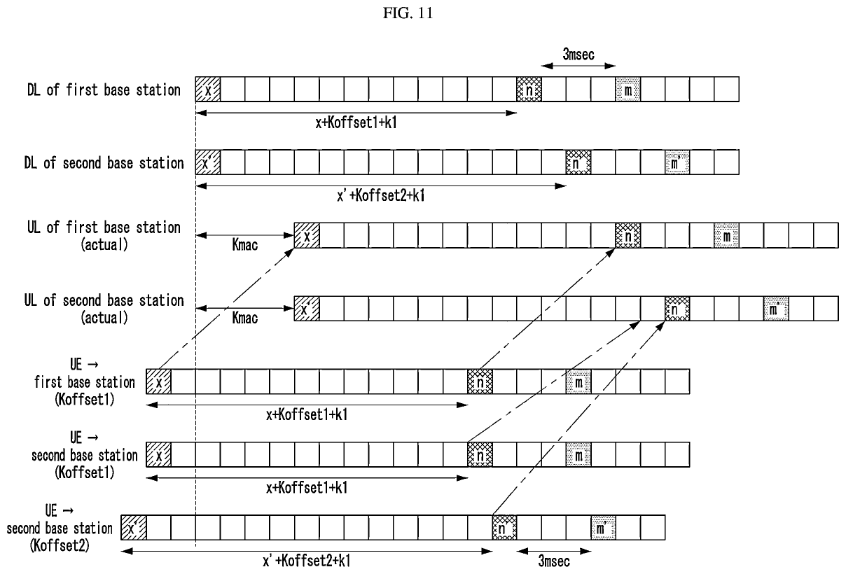

FIG. 11 is a conceptual diagram illustrating an embodiment of a timing relationship between a source cell and a target cell.

As shown in FIG. 11, a first base station (e.g., first satellite) may form a source cell (e.g., serving cell) and a second base station (e.g., second satellite) may form a target cell. A K offset of the first base station may be a Koffset1 (e.g., first K offset). A K offset of the second base station may be a Koffset2 (e.g., second K offset). The first K offset and the second K offset may be different from each other. When the UE is handed over from the first base station to the second base station, if the UE performs UL transmission using the first K offset instead of the second K offset, a timing problem may occur in a reception operation at the second base station.

### Method 1 for Obtaining a Scheduling Offset in a Handover Procedure of EFB NTN

In a handover procedure, a UE operating in an RRC connected state may stop communication (e.g., transmission operation and/or reception operation) with a satellite, receive system information broadcast from the satellite, and identify a scheduling offset (e.g., cell-specific K offset) included in the system information. To support the above-described operation, a triggering operation for obtaining the scheduling offset, measurement operation of a received signal strength (e.g., reception quality) of the system information, and/or decoding operation of the system information may be required.

For example, a triggering condition for obtaining the scheduling offset may be an event A3. An offset of the event A3 used in the procedure of obtaining the scheduling offset may be different from an offset of an event A3 used in a handover procedure. According to Method 1, communication between the UE and the satellite may be stopped. In addition, if a transmission periodicity of the system information including the scheduling offset is not short enough, an additional delay may occur in the handover procedure.

### Method 2 for Obtaining a Scheduling Offset in a Handover Procedure of EFB NTN

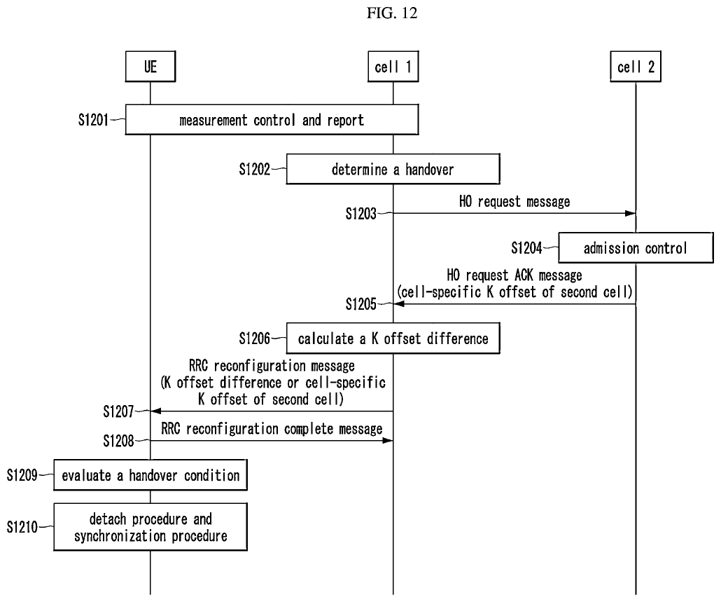

FIG. 12 is a sequence chart illustrating an embodiment of a handover procedure in NTN.

As shown in FIG. 12, a UE may be handed over from a first cell to a second cell. A handover procedure shown in FIG. 12 may be applied to EFB NTN and/or EMB NTN. In the embodiment shown in FIG. 12, the handover procedure may be a legacy handover procedure or a conditional handover (CHO) procedure. The first cell may be a source cell, and the second cell may be a target cell. The first cell and the second cell may be formed by the same satellite. In this case, the handover procedure from the first cell to the second cell may be an intra-satellite (SAT) handover procedure. In an intra-STA handover procedure, an operation (e.g., signaling operation) for obtaining a scheduling offset (e.g., cell-specific K offset) of the target cell may be required. The first cell and the second cell may be formed by different satellites. The first cell may be formed by a first satellite and the second cell may be formed by a second satellite. In this case, the handover procedure from the first cell to the second cell may be an inter-SAT handover procedure. In an inter-SAT handover procedure, an operation (e.g., signaling operation) for obtaining a scheduling offset (e.g., cell-specific K offset) of the target cell belonging to a neighboring satellite (e.g., second satellite) may be required.

The UE may be connected to the first cell (e.g., source cell). The UE connected to the first cell may perform communication. For example, the UE may determine an uplink transmission timing based on the scheduling offset (e.g., cell-specific K offset and/or UE-specific K offset) of the first cell. The UE may then perform uplink transmission based on the uplink transmission timing. In a step or operation S1201, the UE may perform a measurement operation on the cell(s) and report a result of the measurement operation (e.g., measurement result) to the first cell. For example, the UE may measure quality(ies) (e.g., received signal strength(s)) of signal(s) received from the cell(s). The signal may be a synchronization signal (e.g., synchronization signal/physical broadcast channel (SS/PBCH) block) and/or a reference signal (e.g., channel state information-reference signal (CSI-RS)). The UE may transmit received signal quality(ies) and/or received signal strength(s) to the first cell.

The first cell may receive the measurement result from the UE. In a step or operation S1202, the first cell may determine whether to perform a handover procedure (e.g., CHO procedure) for the UE based on the measurement result. If the measurement result satisfies a specific event, the first cell may determine that a handover procedure for the UE is required.

When it is determined to perform a handover procedure (e.g., CHO procedure), the first cell may transmit a handover (HO) request message to the second cell, which is the target cell in a step or operation S1203. The HO request message may include an information element requesting transmission of a scheduling offset (e.g., cell-specific K offset). The second cell may receive the HO request message from the first cell. The second cell may determine whether to approve the handover procedure (e.g., CHO procedure) based on the HO request message (S1204). When the handover procedure is approved, the second cell may generate an HO request acknowledgement (ACK) message. The HO request ACK message may include a cell-specific K offset of the second cell. For example, if the HO request message requests transmission of a cell-specific K offset of the second cell, the second cell may generate a HO request ACK message including its cell-specific K offset. The second cell may transmit the HO request ACK message to the first cell in a step or operation S1205.

When the HO request ACK message is received from the second cell, the first cell may determine that the handover procedure for the UE is approved by the second cell. The first cell may identify information element(s) included in the HO request ACK message. For example, the first cell may identify the cell-specific K offset of the second cell included in the HO request ACK message. The first cell may calculate a difference (hereinafter referred to as ‘K offset difference’) between the cell-specific K offset of the first cell and the cell-specific K offset of the second cell in a step or operation S1206.

When the HO request ACK message is received from the second cell, the first cell may generate an RRC reconfiguration message. The RRC reconfiguration message may include configuration information of CHO candidate cell(s) and/or CHO execution condition(s). The RRC reconfiguration message may include the K offset difference calculated in the step or operation S1206. Alternatively, the step or operation S1206 may be omitted. In this case, the RRC reconfiguration message may include the cell-specific K offset of the second cell instead of the K offset difference. The first cell may transmit the RRC reconfiguration message including the K offset difference or the cell-specific K offset of the second cell to the UE in a step or operation S1207. The RRC reconfiguration message may be an HO command message.

The UE may receive the RRC reconfiguration message from the first cell, and identify information elements included in the RRC reconfiguration message (e.g., configuration information of CHO candidate cell(s), CHO execution condition(s), K offset difference, and/or the cell-specific K offset of the second cell). The UE may transmit an RRC reconfiguration complete message to the first cell in response to the

RRC reconfiguration message in a step or operation S1208. The first cell may receive the RRC reconfiguration complete message from the UE.

When the RRC reconfiguration message includes the K offset difference, the UE may determine ‘cell-specific K offset of the first cell+K offset difference’ as the cell-specific K offset of the second cell. Alternatively, when the RRC reconfiguration message includes the cell-specific K offset of the second cell, the UE may identify the cell-specific K offset of the second cell without additional calculation. In addition, when the RRC reconfiguration message is received from the first cell, the UE may evaluate the CHO execution condition indicated by the RRC reconfiguration message in a step or operation S1209. The step or operation S1209 may be performed on the CHO candidate cell(s) indicated by the RRC reconfiguration message.

When the CHO execution condition is satisfied, the UE may execute the handover procedure (e.g., legacy handover procedure or CHO procedure). The CHO execution condition may be an event A3. When the handover procedure is executed, in a step S1210, the UE may perform a detach procedure for the first cell (e.g., old cell) and may perform a synchronization procedure for the second cell (e.g., new cell). When the step or operation S1210 is completed, the handover procedure for the UE may be completed. According to the above-described operations, the UE may be handed over from the first cell to the second cell. The UE may be connected to the second cell and may perform communication with the second cell. In this case, the UE may perform UL transmission considering the cell-specific K offset of the second cell. For example, the UE may determine an uplink transmission timing based on the cell-specific K offset of the second cell. The UE may then perform uplink communication with the second cell based on the uplink transmission timing.

In the above-described embodiment, when it is not easy to receive the cell-specific K offset through system information (e.g., SIB), when the update delay of the cell-specific K offset through system information is large, and/or when the UE-specific K offset is operated, the first cell (e.g., current cell, source cell) may inform information of the cell-specific K offset of the second cell, which is obtained from the second cell (e.g., new cell), to the UE using a MAC command (e.g., MAC CE) or RRC signaling.

### Method for Signaling and/or Updating a Scheduling Offset in a Handover Procedure of EMB NTN

In the EMB NTN, since distances between UEs belonging to a specific cell and a satellite forming the specific cell are similar, an update procedure of a scheduling offset (e.g., cell-specific K offset) may not be necessarily required. However, if the size of the cell is quite large, a large different may occur in the distances between the UEs and the satellite depending on locations of the UEs. Considering the altitude of the LEO satellite (e.g., 600 km), the difference in the distances between the UEs and the satellite may not be large. In this case, it may be beneficial that the update procedure of the cell-specific K offset is not considered.

In a handover procedure of a UE, the UE may need to obtain a cell-specific K offset of a new cell (e.g., target cell). The cell-specific K offset of the target cell may be different from a cell-specific K offset of a source cell. The UE may identify a timing relationship with the target cell based on the cell-specific K offset of the target cell.

### Method 1 for Obtaining a Scheduling Offset in a Handover Procedure of EMB NTN

In a handover procedure, a UE operating in an RRC connected state may stop communication (e.g., transmission operation and/or reception operation) with a satellite, receive system information broadcast from the satellite, and identify a scheduling offset (e.g., cell-specific K offset) included in the system information. To support the above-described operation, a triggering operation for obtaining the scheduling offset, measurement operation of a received signal strength (e.g., reception quality) of the system information, and/or decoding operation of the system information may be required.

For example, a triggering condition for obtaining the scheduling offset may be an event A3. An offset of the event A3 used in the procedure of obtaining the scheduling offset may be different from an offset of an event A3 used in a handover procedure. According to Method 1, communication between the UE and the satellite may be stopped. In addition, if a transmission periodicity of the system information including the scheduling offset is not short enough, an additional delay may occur in the handover procedure.

### Method 2 for Obtaining a Scheduling Offset in a Handover Procedure of EMB NTN

A source cell may obtain a cell-specific K offset of a target cell from the target cell. For example, the source cell may receive, from the target cell, an HO request ACK message including the cell-specific K offset of the target cell. The source cell may inform the UE of information on the cell-specific K offset of the target cell by using a MAC command and/or RRC signaling. The source cell may inform the UE of the target cell's cell-specific K offset itself. Alternatively, the source cell may calculate a difference between a cell-specific K offset of the source cell and the cell- specific K offset of the target cell (i.e., ‘K offset difference’) and inform the UE of the K offset difference.

In EMB NTN, cells may change continuously, and a difference between the cell-specific K offsets of the cells may not be large. In other words, the K offset difference may not be large. If the K offset difference is signaled instead of the cell-specific K offset in the intra-SAT handover procedure, signaling overhead may be reduced.

If a UE-specific K offset is used, the cell-specific K offset of the target cell and/or the UE-specific K offset may be transmitted to the UE through a MAC command and/or RRC signaling. For example, the source cell may obtain the cell-specific K offset of the target cell and/or the UE-specific K offset from the target cell, and transmit the cell-specific K offset of the target cell and/or UE-specific K offset to the UE through a MAC command and/or RRC signaling. To support the above-described operation, the HO request message transmitted from the source cell to the target cell may include an information element indicating whether to use the UE-specific K offset. Accordingly, the HO request message may inform the target cell whether the UE uses the UE-specific K offset.

The target cell may receive the HO request message from the source cell and identify whether the UE-specific K offset is used in the UE based on the information element included in the HO request message. If the UE-specific K offset is used in the UE, the target cell may transmit a HO request ACK message including the UE-specific K offset to the source cell. On the other hand, if the UE-specific K offset is not used in the UE, the HO request ACK message may not include the UE-specific K offset of the target cell. Alternatively, if whether to use the UE-specific K offset is preconfigured, the above-described operation for notifying the use of the UE-specific K offset may not be performed.

The methods according to embodiments of the present disclosure may be implemented as program instructions executable by a variety of computers and/or processors and recorded on a computer readable medium. The computer readable medium may include a program instruction, a data file, a data structure, or a combination thereof. The program instructions recorded on the computer readable medium may be designed and configured specifically for embodiments of the present disclosure or may be publicly known and available to those having ordinary skill in the art to which the present disclosure pertains.

Examples of the computer readable medium may include a hardware device such as ROM, RAM, and flash memory, that are specifically configured to store and execute the program instructions. Examples of the program instructions include machine codes made by, for example, a compiler, as well as high-level language codes executable by a computer, using an interpreter. The hardware device may be configured to operate as at least one software module in order to perform operations according to embodiments of the present disclosure, and vice versa.

While example embodiments of the present disclosure and their advantages have been described above, it should be understood that various changes, substitutions and/or alterations may be made without departing from the scope of the present disclosure.

What is claimed is:

1. A method of a satellite, the method comprising:
transmitting first system information including a first scheduling offset to a user equipment (UE);
determining a first update periodicity of the first scheduling offset;
transmitting a first message including information on the first update periodicity to the UE; and
transmitting a second message including information on a scheduling offset updated according to the first update periodicity to the UE,
wherein each of the first scheduling offset and the updated scheduling offset is used to determine an uplink transmission timing at the UE.

2. The method according to claim 1, further comprising:
transmitting a third message including information on a second update periodicity of the first scheduling offset to the UE; and
transmitting a fourth message including information on a scheduling offset updated according to the second update periodicity to the UE,
wherein the second update periodicity is different from the first update periodicity.

3. The method according to claim 2, further comprising, when a preset condition is satisfied, changing an update periodicity of the first scheduling offset from the first update periodicity to the second update periodicity.

4. The method according to claim 3, wherein the preset condition includes at least one of a case when an elevation angle between the satellite and a cell formed by the satellite exceeds a first threshold, a case when the elevation angle is equal to or less than the first threshold, a case when a distance between the satellite and the cell exceeds a second threshold, or a case when the distance is equal to or less than the second threshold.

5. The method according to claim 1, further comprising:
transmitting second system information including a second scheduling offset to the UE;
determining a third update periodicity of the second scheduling offset;
transmitting a fifth message including information on the third update periodicity to the UE; and
transmitting a sixth message including information on a scheduling offset updated according to the third update periodicity to the UE,
wherein the third update periodicity is different from the first update periodicity.

6. The method according to claim 1, wherein the first scheduling offset is at least one of a cell-specific K offset or a UE-specific K offset.

7. The method according to claim 1, wherein:
the first message is a radio resource control (RRC) message; and
the second message is a medium access control (MAC) control element (CE).

8. The method according to claim 1, wherein the information on the updated scheduling offset indicates at least one of an increase amount or a decrease amount compared to the first scheduling offset or a previous scheduling offset.

9. A method of a user equipment (UE), the method comprising:
receiving first system information including a first scheduling offset from a satellite;
receiving a first message including information on a first update periodicity of the first scheduling offset from the satellite;
receiving a second message including information on a scheduling offset updated according to the first update periodicity from the satellite;
determining an uplink transmission timing based on the updated scheduling offset; and
performing uplink transmission based on the uplink transmission timing.

10. The method according to claim 9, further comprising:
receiving a third message including information on a second update periodicity of the first scheduling offset from the satellite; and
receiving a fourth message including information on a scheduling offset updated according to the second update periodicity from the satellite,
wherein the second update periodicity is different from the first update periodicity.

11. The method according to claim 10, wherein an update periodicity of the first scheduling offset is changed from the first update periodicity to the second update periodicity when a preset condition is satisfied in the satellite.

12. The method according to claim 9, further comprising:
receiving second system information including a second scheduling offset from the satellite;
receiving a fifth message including information on a third update periodicity of the second scheduling offset from the satellite; and
receiving a sixth message including information on a scheduling offset updated according to the third update periodicity from the satellite,
wherein the third update periodicity is different from the first update periodicity.

13. The method according to claim 9, wherein the first scheduling offset is at least one of a cell-specific K offset or a UE-specific K offset.

14. The method according to claim 9, wherein the first message is a radio resource control (RRC) message, and the second message is a medium access control (MAC) control element (CE).

15. The method according to claim 9, wherein the information on the updated scheduling offset indicates at least one of an increase amount or a decrease amount compared to the first scheduling offset or a previous scheduling offset.

16. A method of a first cell, the method comprising:
performing uplink communication with a user equipment (UE) according to an uplink transmission timing determined based on a first scheduling offset of the first cell;
determining a handover based on a measurement result received from the UE;
transmitting a handover (HO) request message to a second cell;
receiving a HO request acknowledgement (ACK) message including a second scheduling offset of the second cell from the second cell; and
transmitting a radio resource control (RRC) reconfiguration message including information on the second scheduling offset to the UE.

17. The method according to claim 16, wherein the HO request message includes an information element requesting transmission of the second scheduling offset.

18. The method according to claim 16, further comprising calculating a difference between the first scheduling offset and the second scheduling offset, wherein the information on the second scheduling offset includes the difference.

19. The method according to claim 16, wherein the first cell and the second cell are formed by one of a same satellite or different satellites.

20. The method according to claim 16, wherein each of the first scheduling offset and the second scheduling offset is at least one of a cell-specific K offset or a UE-specific K offset.
